(19) United States
(12) Patent Application Publication
(10) Pub. No.: US 2017/0243226 A1
(43) Pub. Date: Aug. 24, 2017

(54) System and Method for Accelerated Asset Ownership Registration

(71) Applicant: DELL PRODUCTS, LP, Round Rock, TX (US)

(72) Inventor: Ulisses P. Giorgi, Porto Alegre (BR)

(21) Appl. No.: 15/052,022

(22) Filed: Feb. 24, 2016

(51) Int. Cl. G06Q 30/00

(52) U.S. Cl. CPC G06Q 30/012

(57) ABSTRACT

A support system includes first and second information handling systems. The first information handling system includes a first management module to provide user data from the first information handling system to a support system, register the first information handling system to the support system based upon the user data, determine that a second information handling system coupled to the network is not registered to the support system, and provide the user data to the second information handling system in response to determining that the second information handling system is not registered to the support system. The second information handling system includes a second management module to register the second information handling system to the support system based upon the user data.

### FIELD OF THE DISCLOSURE

This disclosure generally relates to information handling systems, and more particularly relates to a system and method for accelerated asset ownership registration in an information handling system.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources that may be configured to process, store, and communicate information and may include one or more computer systems, data storage systems, and networking systems.

### SUMMARY

A support system can include first and second information handling systems. The first information handling system can include a first management module to provide user data from the first information handling system to a support system, to register the first information handling system to the support system based upon the user data, to determine that a second information handling system coupled to the network is not registered to the support system, and to provide the user data to the second information handling system in response to determining that the second information handling system is not registered to the support system. The second information handling system can include a second management module to register the second information handling system to the support system based upon the user data

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIGS. 1-3 are block diagrams of a managed system according to an embodiment of the present disclosure; and

FIG. 4 is a block diagram illustrating a generalized information handling system according to an embodiment of the present disclosure.

The use of the same reference symbols in different drawings indicates similar or identical items.

### DETAILED DESCRIPTION OF DRAWINGS

The following description in combination with the Figures is provided to assist in understanding the teachings disclosed herein, and will focus on specific implementations and embodiments of the teachings. This focus is provided to assist in describing the teachings, and should not be interpreted as limiting the scope or applicability of the teachings. Moreover, other teachings can be used along with the teachings of this disclosure, and the teachings of this disclosure can be used along with other disclosures.

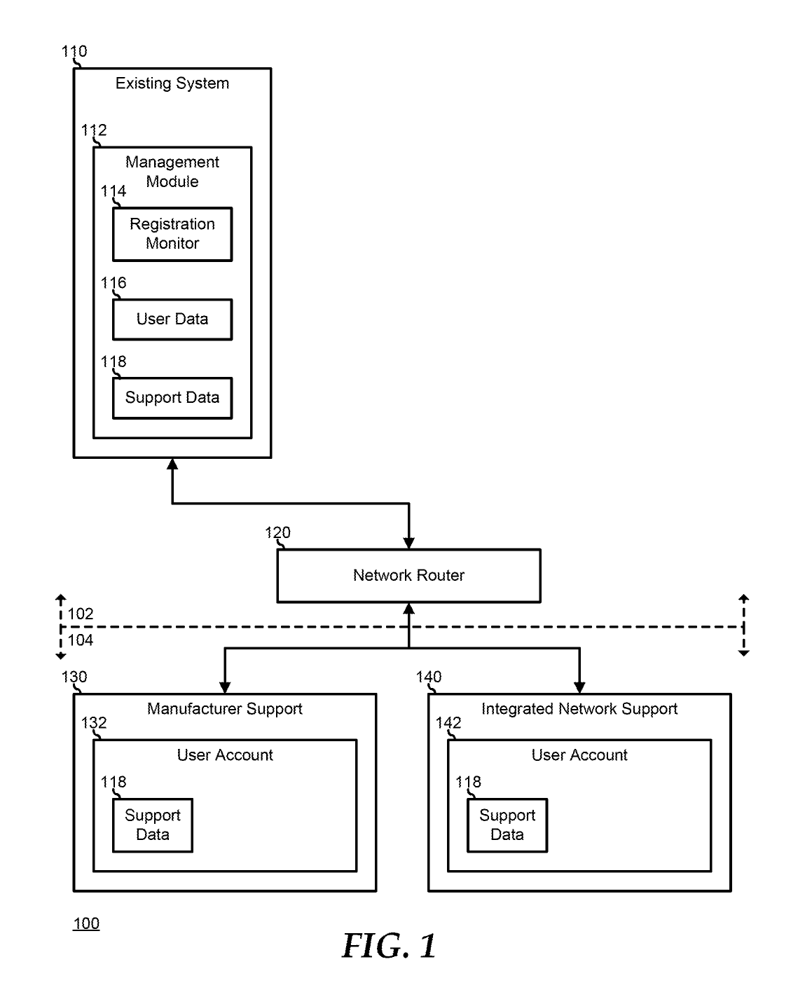

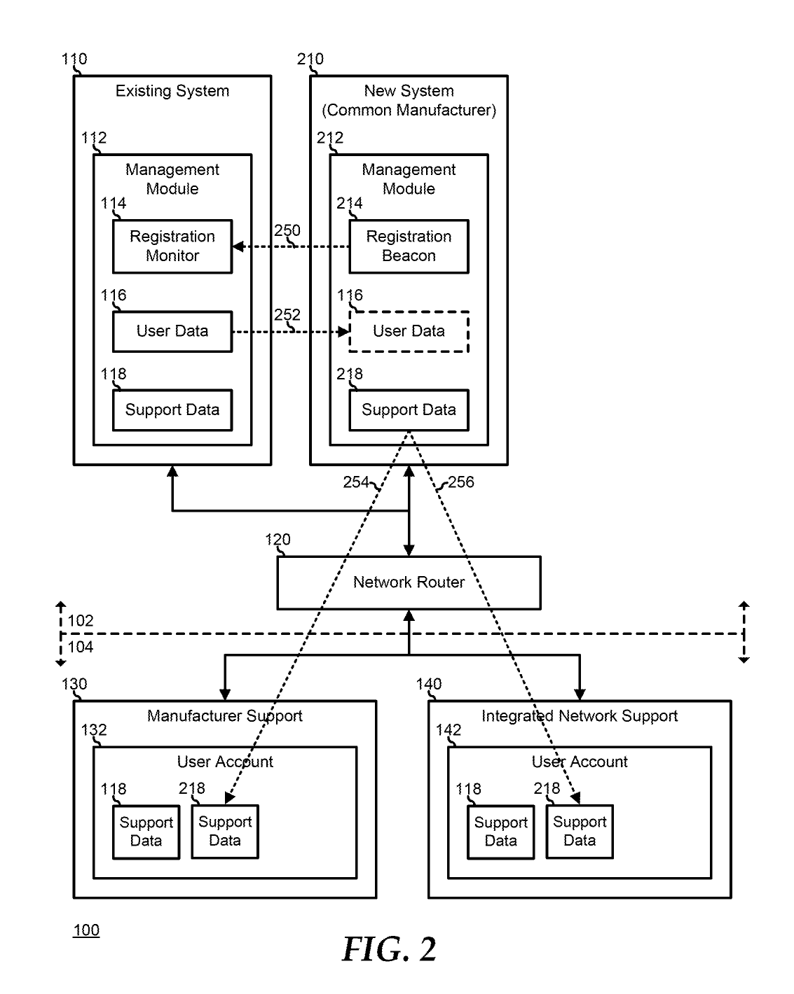

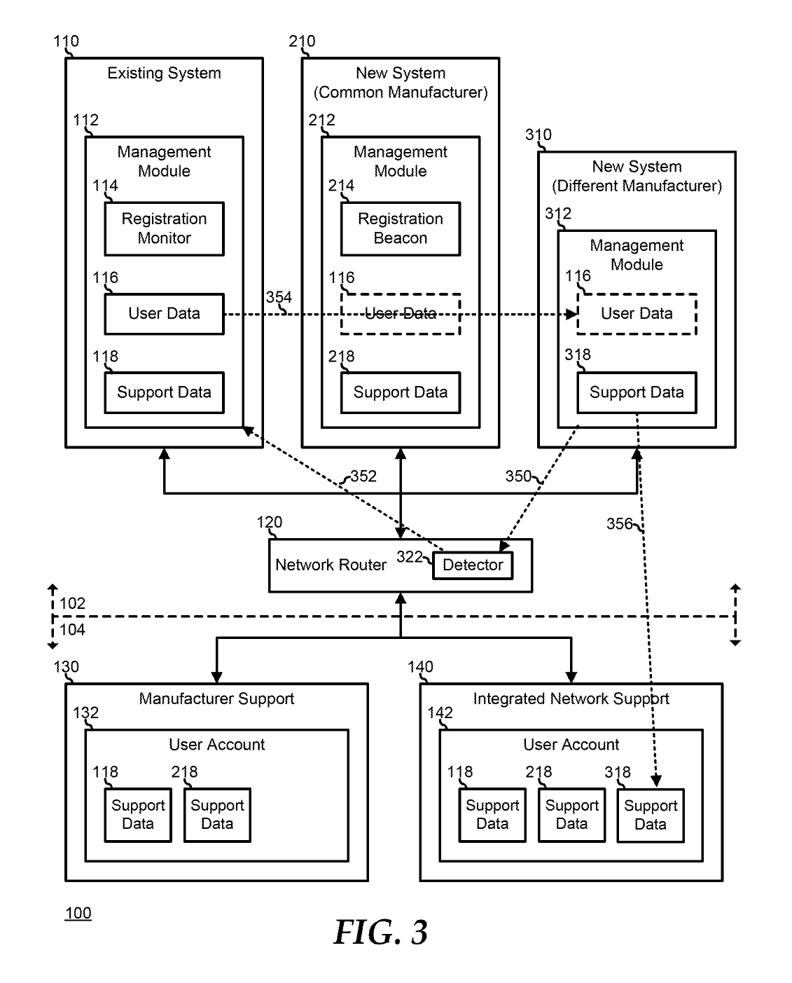

FIGS. 1-3 illustrate an embodiment of a support system 100 including a supported network 102 and a support network 104. Supported network 102 represents a group of information handling systems that are commonly managed or owned, and that are typically connected together in such a way as to be able to communicate with each other and with the elements of support network 104. As shown in FIG. 1, supported network 102 includes an information handling system 110 and a network router 120. Supported network 102 can be expanded to include one or more additional information handling systems, as shown in FIGS. 2 and 3, and as described further, below.

Information handling system 110 represents a network connected device, such as a computer, a laptop, a tablet or smart phone, a printer, or the like, a network connected entertainment device such as a digital video recorder, a smart television, a gaming console, or the like, a smart appliance such as a refrigerator, a washer, a home security system, or the like, or another network connected device such as may be considered as an Internet-of-Things (IoT) device, or a combination thereof. Network router 120 operates to connect information handling system 110 to the other information handling systems of supported network 102, as described further, below, and to support network 104.

Support network 104 represents a group of information handling systems that operate to provide support services for information handling system 110 and the other information handling systems of supported network 102, as described further, below. Support network 104 includes a manufacturer support system 130 and an integrated network support system 140. In a particular embodiment, support systems 130 and 140 operate to monitor, manage, and maintain information handling system 110. Here, manufacturer support system 130 represents a support system established by a particular manufacturer associated with information handling system 110, and the manufacturer support system operates to provide manufacturer support for the information handling system, such as to monitor the performance of the information handling system, to manage and maintain the software, hardware, firmware, licensing, and other operations of the information handling system, and to maintain the software, firmware, and licenses, providing downloads of new revisions of the software, firmware, and licenses, as needed or desired. Here, where supported system 102 includes more than one information handling system that is associated with manufacturer support system 130, the manufacturer support system provides a unified look and feel to the monitoring, management, and maintenance of the various information handling systems.

Integrated network support system 140 is similar to manufacturer support system 130, in terms of the monitoring, management, and maintenance of information handling system 110. However, integrated network support system 140 operates to provide monitoring, management, and maintenance for information handling systems of supported network 102 that may, or may not be manufactured by a common manufacturer. For example, integrated network support system 140 may be associated with supported network 102 via a contracted service plan to provide the monitoring, management, and maintenance for information handling systems of supported network 102, without regard to a particular information handling system's manufacturer.

Information handling system 110 includes a management module 112 that operates to interact with manufacturer support system 130 and integrated network support system 140 such that information handling system 110 can be monitored, managed, and maintained by the support systems. As such, management module 112 can include one or more Application Program Interfaces (APIs) that permit manufacturer support system 130 and integrated network support system 140 to access the functions and features of information handling system 110. For example, management module 112 can include an API that provides log data for information handling system 110 to manufacturer support system 130 and integrated network support system 140, an API that monitors system status and recommends various software or firmware updates and the like, an API that permits a support technician of the manufacturer support system and the integrated network support system to interact directly with the information handling system or with a user of the information handling system, and the like. In a particular embodiment, manufacturer support system 130 and integrated network support system 140 can provide product updates or upgrades or suggestions for new or complimentary products to management module 112 for display to the user of the information handling system. For example, using log information provided by management module 112, manufacturer support system 130 can determine that a specific hard drive in information handling system 110 needs to be replaced because the average temperature and RPM (Rotations per Minute) of that hard drive is outside normal standard, or the hard drive is otherwise failing.

Management module 112 includes a registration monitor 114, user data 116, and support data 118. Registration monitor 114 will be described further, below. User data 116 represents information related to the information handling system 110, but that is not directly related to the hardware, software, firmware, programs, computing environment, and the like, of the information handling system. As such, user data 116 includes identifying information for information handling system 110 and the user of the information handling system. For example, user data 116 can include site information related to the location of information handling system 110, user identification information, such as a name, an address, an e-mail address, a credit card number, and the like, as needed or desired. Support data 118 represents information related to the hardware, software, firmware, programs, computing environment, and the like, of information handling system 110. For example, support data 118 can include identification information such as make, model, serial number, or asset tag information, system information such as installed hardware or software options or the like, other system information, or a combination thereof. In a particular embodiment, one or more of user data 116 and support data 118 includes service agreement information related to a level of service that is supported by manufacturer support system 130 and integrated network support system 140.

Manufacturing support system 130 includes a user account 132 that is associated with information handling system 110 and that includes user data 116 (not illustrated) and support data 118, as needed to provide the support functions of the manufacturing support system for the information handling system. Here, it is assumed that information handling system 110 is manufactured by a manufacturer that is associated with manufacturer support system 130. Further, it is assumed that information handling system 110 is pre-registered, or had been registered at a previous time, such that user account 132 is established on manufacturer support system 130, and that support data 118 is pre-loaded, or had been provided to the user account at a previous time. As such, information handling system 110 is designated as “Existing System” in FIGS. 1-3.

Integrated network support system 140 includes a user account 142 similar to user account 132, that is associated with supported network 102, and that includes user data 116 (not illustrated) and support data 118, as needed to provide the support functions of the integrated network support system for the supported network. Here, it is assumed that supported network 102 is associated with integrated network support system 140, and that the supported network is pre-registered, or had been registered at a previous time, such that user account 142 is established on integrated network support system 140. It is further assumed that support data 118 is pre-loaded, or had been provided to user account 142 at a previous time.

FIG. 2 illustrates a point in time where supported network 102 is expanded to include an additional information handling system 210, similar to information handling system 110, that is connected via network router 120 to information handling system 110 and to support network 104, and is associated with the same manufacturer as information handling system 110. Information handling system 210 includes a management module 212 similar to management module 112, and that operates to interact with manufacturer support system 130 and integrated network support system 140 such that information handling system 210 can be monitored, managed, and maintained by the support systems. As such, management module 212 can include one or more APIs similar to management module 112, as described above. In a particular embodiment, information handling system 210 is associated with the same manufacturer as information handling system 110 by virtue of both information handling systems having been manufactured by the same manufacturer. In another embodiment, information handling system 210 is associated with the same manufacturer as information handling system 110 by virtue of both information handling systems being manufactured by different manufacturers, but where both manufacturers design and build their respective information handling systems to a common specification or under an agreement to make their respective information handling systems compatible with each other.

Management module 212 includes a registration beacon 214 and support data 218 that includes similar information to the information in support data 118 that pertains to information handling system 210. When information handling system 210 is added to supported network 102, the information handling system is not registered onto support network 104, and particularly to manufacturer support system 130 and integrated network support system 140. Here, when information handling system 210 is connected to network router 120, registration beacon 214 issues, in a step 250, a beacon, or heartbeat, on supported network 102, indicating that a new and unregistered information handling system has been added to the supported network. In a particular embodiment, the beacon represents a broadcast message on supported network 102 that is received by other elements of the supported network. Specifically, the beacon is detected by registration monitor 114, indicating to management module 112 that information handling system 210 has been added to supported network 102, and that the information handling system is associated with the same manufacturer as information handling system 110. For example, a broadcast message can be sent continuously, or can be sent periodically, as needed or desired. Where a broadcast message is sent periodically the period can be defined based upon a performance characteristic of information handling system 210, as needed or desired.

In response to receiving beacon 250, management module 112 populates, in a step 252, user data 116 to information handling system 210. In this way, information handling system 210 is automatically provided with information related to the user of supported network 102, and with the elements of the supported network, without the user having to manually input user data 116 into management module 212. Then, when user data 116 is populated 252 into management module 212, the management module registers, in a step 254, information handling system 210 onto manufacturer support system 130 by providing support data 218 to user account 132, so that the manufacturer support system can proceed to monitor, manage, and maintain the information handling system. Management module 212 further registers, in a step 256, information handling system 210 onto integrated network support system 140 by providing support data 218 to user account 142, so that the integrated network support system can proceed to monitor, manage, and maintain the information handling system. In a particular embodiment, management module 112 populates 252 user data 116 to information handling system 210 in response to a user authentication process initiated by information handling system 110, where the user enters authentication credentials onto information handling system 210 to confirm the identity of the user and to ensure that information handling system 210 is authorized and intended to be connected to network router 120.

FIG. 3 illustrates a point in time where supported network 102 is expanded to include an additional information handling system 310, similar to information handling system 110 but is not associated with the same manufacturer as information handling system 110. Information handling system 310 is connected via network router 120 to information handling system 110, to information handling system 210, and to support network 104. Information handling system 310 includes a management module 312 similar to management module 112, and that operates to interact with integrated network support system 140 such that information handling system 310 can be monitored, managed, and maintained by the support system. As such, management module 312 can include one or more APIs similar to management module 112, as described above.

Management module 312 includes support data 318 that includes similar information to the information in support data 118 that pertains to information handling system 310. When information handling system 310 is added to supported network 102, the information handling system is not registered onto support network 104, and particularly to integrated network support system 140. Here, when information handling system 310 is connected to network router 120, a detector 322 of network router 120 detects, in a step 350, that a new and unregistered information handling system has been added to the supported network.

In response to detecting information handling system 310, detector 322 alerts, in a step 352, management module 112 of the presence of information handling system 310, and, management module 112 populates, in a step 354, user data 116 to information handling system 310. In this way, information handling system 310 is automatically provided with information related to the user of supported network 102, and with the elements of the supported network, without the user having to manually input user data 116 into management module 312. Then, when user data 116 is populated 354 into management module 312, the management module registers, in a step 356, information handling system 310 onto integrated network support system 140 by providing support data 318 to user account 142, so that the integrated network support system can proceed to monitor, manage, and maintain the information handling system. In a particular embodiment, management module 112 populates 354 user data 116 to information handling system 310 in response to a user authentication process initiated by information handling system 110, where the user enters authentication credentials onto information handling system 310 to confirm the identity of the user and to ensure that information handling system 310 is authorized and intended to be connected to network router 120.

In a particular embodiment, information handling system 310 is associated with the same manufacturer as information handling system 110. Here, management module 312 further registers information handling system 310 onto manufacturer support system 130 by providing support data 318 to user account 132, so that the manufacturer support system can proceed to monitor, manage, and maintain the information handling system

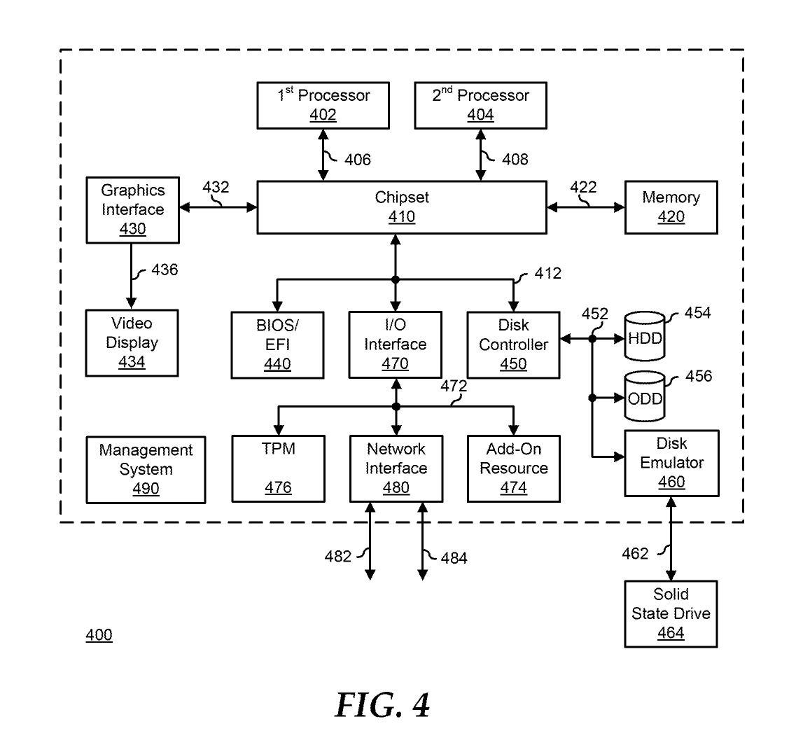

FIG. 4 illustrates a generalized embodiment of information handling system 400. For purpose of this disclosure information handling system 400 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 400 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 400 can include processing resources for executing machine-executable code, such as a central processing unit (CPU), a programmable logic array (PLA), an embedded device such as a System-on-a-Chip (SoC), or other control logic hardware. Information handling system 400 can also include one or more computer-readable medium for storing machine-executable code, such as software or data. Additional components of information handling system 400 can include one or more storage devices that can store machine-executable code, one or more communications ports for communicating with external devices, and various input and output (I/O) devices, such as a keyboard, a mouse, and a video display. Information handling system 400 can also include one or more buses operable to transmit information between the various hardware components.

Information handling system 400 can include devices or modules that embody one or more of the devices or modules described above, and operates to perform one or more of the methods described above. Information handling system 400 includes a processors 402 and 404, a chipset 410, a memory 420, a graphics interface 430, include a basic input and output system/extensible firmware interface (BIOS/EFI) module 440, a disk controller 450, a disk emulator 460, an input/output (I/O) interface 470, a network interface 480, and a management system 490. Processor 402 is connected to chipset 410 via processor interface 406, and processor 404 is connected to the chipset via processor interface 408. Memory 420 is connected to chipset 410 via a memory bus 422. Graphics interface 430 is connected to chipset 410 via a graphics interface 432, and provides a video display output 436 to a video display 434. In a particular embodiment, information handling system 400 includes separate memories that are dedicated to each of processors 402 and 404 via separate memory interfaces. An example of memory 420 includes random access memory (RAM) such as static RAM (SRAM), dynamic RAM (DRAM), non-volatile RAM (NV-RAM), or the like, read only memory (ROM), another type of memory, or a combination thereof

BIOS/EFI module 440, disk controller 450, and I/O interface 470 are connected to chipset 410 via an I/O channel 412. An example of I/O channel 412 includes a Peripheral Component Interconnect (PCI) interface, a PCI-Extended (PCI-X) interface, a high speed PCI-Express (PCIe) interface, another industry standard or proprietary communication interface, or a combination thereof. Chipset 410 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/EFI module 440 includes BIOS/EFI code operable to detect resources within information handling system 400, to provide drivers for the resources, initialize the resources, and access the resources. BIOS/EFI module 440 includes code that operates to detect resources within information handling system 400, to provide drivers for the resources, to initialize the resources, and to access the resources.

Disk controller 450 includes a disk interface 452 that connects the disc controller to a hard disk drive (HDD) 454, to an optical disk drive (ODD) 456, and to disk emulator 460. An example of disk interface 452 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 460 permits a solid-state drive 464 to be connected to information handling system 400 via an external interface 462. An example of external interface 462 includes a USB interface, an IEEE 1394 (Firewire) interface, a proprietary interface, or a combination thereof. Alternatively, solid-state drive 464 can be disposed within information handling system 400.

I/O interface 470 includes a peripheral interface 472 that connects the I/O interface to an add-on resource 474, to a TPM 476, and to network interface 480. Peripheral interface 472 can be the same type of interface as I/O channel 412, or can be a different type of interface. As such, I/O interface 470 extends the capacity of I/O channel 412 when peripheral interface 472 and the I/O channel are of the same type, and the I/O interface translates information from a format suitable to the I/O channel to a format suitable to the peripheral channel 472 when they are of a different type. Add-on resource 474 can include a data storage system, an additional graphics interface, a network interface card (NIC), a sound/video processing card, another add-on resource, or a combination thereof. Add-on resource 474 can be on a main circuit board, on separate circuit board or add-in card disposed within information handling system 400, a device that is external to the information handling system, or a combination thereof

Network interface 480 represents a NIC disposed within information handling system 400, on a main circuit board of the information handling system, integrated onto another component such as chipset 410, in another suitable location, or a combination thereof. Network interface device 480 includes network channels 482 and 484 that provide interfaces to devices that are external to information handling system 400. In a particular embodiment, network channels 482 and 484 are of a different type than peripheral channel 472 and network interface 480 translates information from a format suitable to the peripheral channel to a format suitable to external devices. An example of network channels 482 and 484 includes InfiniBand channels, Fibre Channel channels, Gigabit Ethernet channels, proprietary channel architectures, or a combination thereof. Network channels 482 and 484 can be connected to external network resources (not illustrated). The network resource can include another information handling system, a data storage system, another network, a grid management system, another suitable resource, or a combination thereof.

Management controller 490 provides for out-of-band monitoring, management, and control of the respective elements of information handling system 400, such as cooling fan speed control, power supply management, hot-swap and hot-plug management, firmware management and update management for system BIOS or UEFI, Option ROM, device firmware, and the like, or other system management and control functions as needed or desired. As such, management system 490 provides some or all of the functions and features of the management systems described herein.

The preceding description in combination with the Figures is provided to assist in understanding the teachings disclosed herein. The preceding discussion focused on specific implementations and embodiments of the teachings. This focus has been provided to assist in describing the teachings, and should not be interpreted as a limitation on the scope or applicability of the teachings. However, other teachings can certainly be used in this application. The teachings can also be used in other applications, and with several different types of architectures, such as distributed computing architectures, client/server architectures, or middleware server architectures and associated resources.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

When referred to as a “device,” a “module,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device).

The device or module can include software, including firmware embedded at a device, such as a Pentium class or PowerPC™ brand processor, or other such device, or software capable of operating a relevant environment of the information handling system. The device or module can also include a combination of the foregoing examples of hardware or software. Note that an information handling system can include an integrated circuit or a board-level product having portions thereof that can also be any combination of hardware and software.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

1. A method, comprising:
coupling a first information handling system to a network;
providing, from the first information handling system, user data and first support data associated with the first information handling system to a support system;
registering the first information handling system to the support system based upon the user data;
coupling a second information handling system to the network;
determining, by the first information handling system, that the second information handling system is not registered to the support system;
providing the user data from the first information handling system to the second information handling system in response to determining that the second information handling system is not registered to the support system;
providing, from the second information handling system, second support data associated with the second information handling system to the support system; and
registering the second information handling system to the support system based upon the user data.

2. The method of claim 1, further comprising:
providing a beacon via the network from the second information handling system to the first information handling system in response to coupling the second information handling system to the network.

3. The method of claim 2, wherein determining that the second information handling system is not registered to the support system is in response to providing the beacon to the first information handling system.

4. (canceled)

5. The method of claim 1, wherein in registering the first information handling system to the support system based upon the user data, the method further comprises:
providing first support data associated with the first information handling system to the support system.

6. The method of claim 5, wherein in registering the second information handling system to the support system based upon the user data, the method further comprises:
providing second support data associated with the second information handling system to the support system.

7. The method of claim 1, further comprising:
detecting, by the network, that the second information handling system is a new information handling system to the network.

8. The method of claim 7, wherein determining that the second information handling system is not registered to the support system is in response to detecting that the second information handling system is the new information handling system.

9. (canceled)

10. A non-transitory computer-readable medium including code for performing a method, the method comprising:
coupling a first information handling system to a network;
providing, from the first information handling system, user data and first support data associated with the first information handling system to a support system;
registering the first information handling system to the support system based upon the user data;
coupling a second information handling system to the network;
determining, by the first information handling system, that the second information handling system is not registered to the support system;
providing the user data from the first information handling system to the second information handling system in response to determining that the second information handling system is not registered to the support system;
providing, from the second information handling system, second support data associated with the second information handling system to the support system; and
registering the second information handling system to the support system based upon the user data.

11. The computer-readable medium of claim 10, the method further comprising:
providing a beacon via the network from the second information handling system to the first information handling system in response to coupling the second information handling system to the network.

12. The computer-readable medium of claim 11, wherein determining that the second information handling system is not registered to the support system is in response to providing the beacon to the first information handling system.

13. (canceled)

14. The computer-readable medium of claim 10, wherein in registering the first information handling system to the support system based upon the user data, the method further comprises:
providing first support data associated with the first information handling system to the support system.

15. The computer-readable medium of claim 14, wherein in registering the second information handling system to the support system based upon the user data, the method further comprises:
providing second support data associated with the second information handling system to the support system.

16. The computer-readable medium of claim 10, further comprising:
detecting, by the network, that the second information handling system is a new information handling system to the network.

17. The computer-readable medium of claim 16, wherein determining that the second information handling system is not registered to the support system is in response to detecting that the second information handling system is the new information handling system.

18. (canceled)

19. A support system, comprising:
a first information handling system coupled to a network including a first management module to:
provide user data and first support data associated with the first information handling system to a support system;
register the first information handling system to the support system based upon the user data;
determine that a second information handling system coupled to the network is not registered to the support system; and
provide the user data to the second information handling system in response to determining that the second information handling system is not registered to the support system; and
the second information handling system including a second management module to:
provide second support data associated with the second information handling system to the support system; and
register the second information handling system to the support system based upon the user data

20. The support system of claim 19, wherein:
the second management module is further to provide a beacon via the network to the first information handling system; and
determining that the second information handling system is not registered to the support system is in response to providing the beacon to the first information handling system.

21. The method of claim 1, wherein the first support information comprises one of a make of the first information handling system, a model of the first information handling system, a serial number of the first information handling system, and an asset tag of the first information handling system.

22. The method of claim 1, wherein the first support information comprises one of a list of hardware of the first information handling system, a list of software of the first information handling system, a list of firmware of the first information handling system, a list of programs of the first information handling system, and an operating environment of the first information handling system.

23. The computer-readable medium of claim 10, wherein the first support information comprises one of a make of the first information handling system, a model of the first information handling system, a serial number of the first information handling system, and an asset tag of the first information handling system.

24. The support system of claim 19, wherein the first support information comprises one of a make of the first information handling system, a model of the first information handling system, a serial number of the first information handling system, and an asset tag of the first information handling system
